(19) United States
(12) Patent Application Publication
(10) Pub. No.: US 2024/0104419 A1
(43) Pub. Date: Mar. 28, 2024

(54) COMPRESSING OPERATION DATA FOR ENERGY SAVING

(71) Applicant: INTERNATIONAL BUSINESS MACHINES CORPORATION, ARMONK, NY (US)

(72) Inventors: FAN JING Meng, Beijing (CN); Cheng Luo, Beijing (CN); Qi Ye, Shanghai (CN); Jia Tian Zhong, Beijing (CN)

(21) Appl. No.: 17/934,583

(22) Filed: Sep. 23, 2022

(51) Int. Cl. G06N 20/00; G06F 16/28; G06N 5/02

(52) U.S. Cl. CPC G06N 20/00; G06F 16/288; G06N 5/022

(57) ABSTRACT

A method, computer system, and a computer program product for data compression is provided. The present invention may include receiving operational data. The present invention may include profiling the operational data using one or more normalizing functions. The present invention may include extracting a plurality of patterns from the operational data. The present invention may include compressing the operational data based on the plurality of patterns extracted.

### BACKGROUND

The present invention relates generally to the field of computing, and more particularly to data compression.

Modern Information Technology (IT) infrastructure may be becoming increasingly complex due to at least, managed objects, cloud/virtualization applications, distributed system adoption, heterogeneous architecture, and/or availability requirements, amongst other factors. Modern IT may require a number of visibility tools to collect operational data from a full stack of hardware, operating systems, virtualization, middleware, applications, and third party services. This operational data may include, but is not limited to including, monitoring metrics, logs, events, tickets, traces, amongst other operational data. Accordingly, it may require a large-scale data platform to collect, process, store, visualize, analyze, and archive operational data.

Operational data compression may aim to save space and/or energy in storing large amounts of operational data. Current operational data compression methods rely mostly on general data compression or record based compression which may lead to a low compression ratio for operational data.

### SUMMARY

Embodiments of the present invention disclose a method, computer system, and a computer program product for data compression. The present invention may include receiving operational data. The present invention may include profiling the operational data using one or more normalizing functions. The present invention may include extracting a plurality of patterns from the operational data. The present invention may include compressing the operational data based on the plurality of patterns extracted.

In another embodiment, the method may include constructing a key value set, wherein the key value set is in a common format and comprised of a plurality of entities and relationships between the plurality of entities.

In a further embodiment, the method may include building one or more dictionaries based on at least the key value set and the plurality of patterns extracted from the operational data; and storing the one or more dictionaries in a knowledge corpus.

In yet another embodiment, the method may include utilizing the one or more dictionaries in compressing the operational data.

In addition to a method, additional embodiments are directed to a computer system and a computer program product for compressing operational data based on, line-level, sequence level, and/or graph-level log compression based on operational data patterns extracted using one or more machine earning models, deep learning models, and/or natural language processing techniques.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment; and

FIG. 2 is an operational flowchart illustrating a process for data compression according to at least one embodiment.

### DETAILED DESCRIPTION

The following described exemplary embodiments provide a system, method and program product for data compression. As such, the present embodiment has the capacity to improve the technical field of data compression by compressing operational data based on, line-level, sequence level, and/or graph-level log compression based on operational data patterns extracted using one or more machine earning models, deep learning models, and/or natural language processing techniques. More specifically, the present invention may include receiving operational data. The present invention may include profiling the operational data using one or more normalizing functions. The present invention may include extracting a plurality of patterns from the operational data. The present invention may include compressing the operational data based on the plurality of patterns extracted.

As described previously, Modern Information Technology (IT) infrastructure may be becoming increasingly complex due to at least, managed objects, cloud/virtualization applications, distributed system adoption, heterogeneous architecture, and/or availability requirements, amongst other factors. Modern IT may require a number of visibility tools to collect operational data from a full stack of hardware, operating systems, virtualization, middleware, applications, and third party services. This operational data may include, but is not limited to including, monitoring metrics, logs, events, tickets, traces, amongst other operational data. Accordingly, it may require a large-scale data platform to collect, process, store, visualize, analyze, and archive operational data.

Operational data compression may aim to save space and/or energy in storing large amounts of operational data. Current operational data compression methods rely mostly on general data compression or record based compression which may lead to a low compression ratio for operational data.

According to at least one embodiment, the present invention may improve the low compression ratio of operational data compression in general data compression approaches and/or record-based compression approaches by using the operational data characteristics and/or relationships derived using machine learning, deep learning, and/or natural language processing techniques.

According to at least one embodiment, the present invention may improve energy utilization and storage capabilities for operation data by compressing operational data with low or no message loss.

According to at least one embodiment, the present invention may improve the retention of all relevant data stored in operation data by using one or more normalizing techniques in building one or more dictionaries based on log templates which may be stored in a database (e.g., knowledge corpus).

According to at least one embodiment, the present invention may improve operational data compression by log template mining, variable extraction (e.g., variable mining), identifying correlation patterns, multi-variant pattern mining, entity and relationship mining, of the operational data in order to build one or more dictionaries from the extracted operational data patterns, variables, entities, and relationships (e.g., interactions, interdependencies, properties).

According to at least one embodiment, the present invention may improve operational data compression by matching patterns and transforming operational data based on relationships (e.g., interactions, interdependencies, properties) derived from the raw operational data received.

According to at least one embodiment, the present invention may improve storage capacity and/or system performance by minimizing storage space occupied by log data and/or other operational data using key values associated with frequently identified patterns to store operational data.

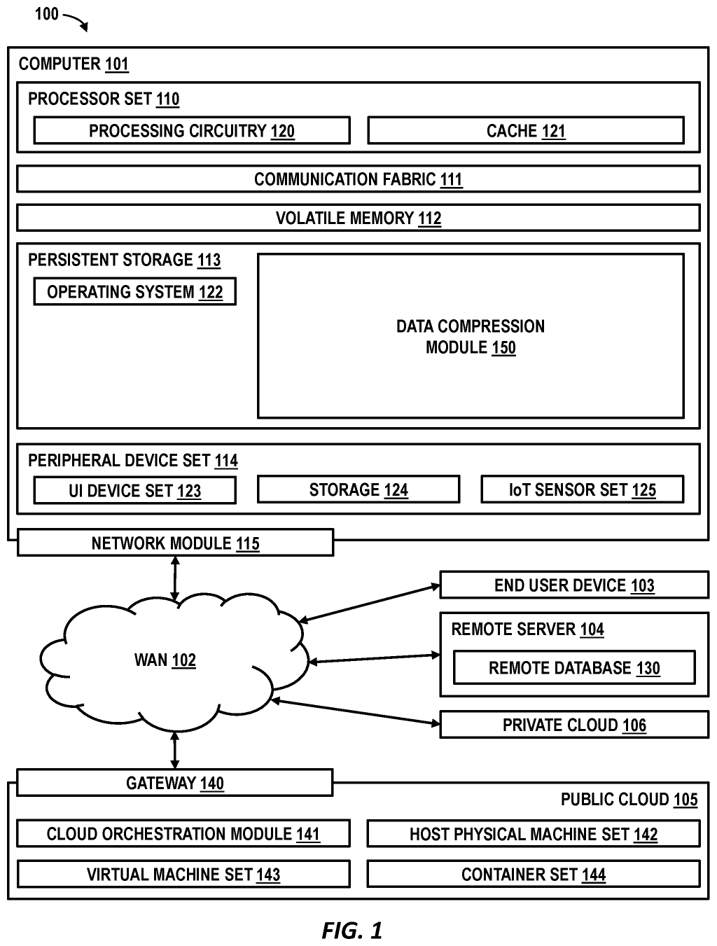

Referring to FIG. 1, Computing environment 100 contains an example of an environment for the execution of at least some of the computer code involved in performing the inventive methods, such as compressing operational data based on, line-level, sequence level, and/or graph-level log compression based on operational data patterns extracted using one or more machine earning models, deep learning models, and/or natural language processing techniques using the data compression module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the Internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

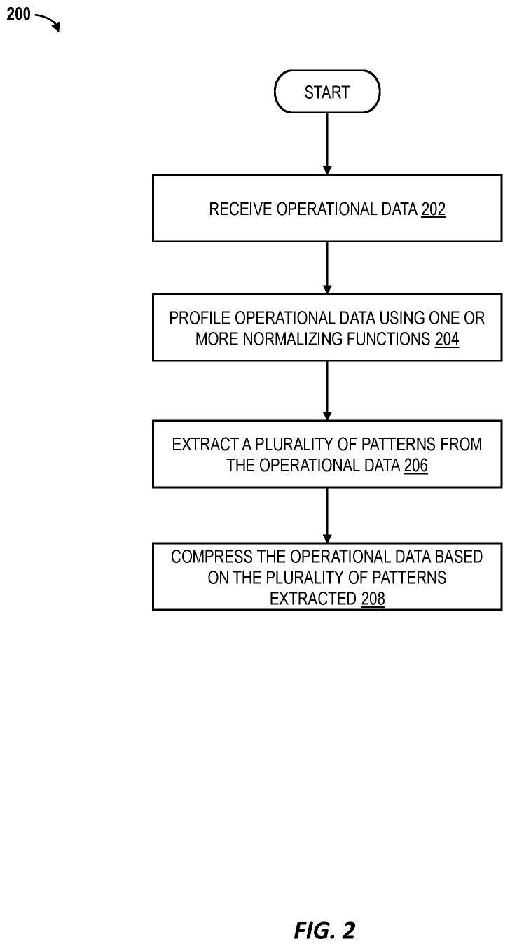

According to the present embodiment, the computer environment 100 may use the data compression module 150 to compress operational data based on, line-level, sequence level, and/or graph-level log compression based on operational data patterns extracted using one or more machine earning models, deep learning models, and/or natural language processing techniques. The data compression method is explained in more detail below with respect to FIG. 2.

Referring now to FIG. 2, an operational flowchart illustrating the exemplary data compression process 200 used by the data compression module 150 according to at least one embodiment is depicted.

At 202, the data compression module 150 receives operational data. The data compression module 150 may receive operational data related to one or more applications, such as, but not limited to, monitoring data, operational logs, events/alerts, tickets/incidents, change or service requests, trace data, process event logs, database logs, system logs, transaction logs, system management facility (SMF) logs, amongst other data related to the one or more applications and/or the one or more application's related environments (e.g., middleware, operating systems).

The one or more applications may each be comprised of a plurality of components, with one or more of the plurality of components interacting with each other and/or being connected via application collaborations. The plurality of components may include, but are not limited to including, a module, data structure, a service, amongst other parts of the one or more applications. The one or more applications for which the operation data may be received may include, but is not limited to including, mainframe applications, 3-tier applications, micro-service applications, batch applications, IoT (Internet of Things) applications, mobile applications, Enterprise applications, amongst other applications and/or combinations of individual applications as part of a computing system. Enterprise applications may include, but are not limited to including, enterprise systems, supply chain management systems, customer relationship management systems, knowledge based systems, amongst other systems which may span multiple functional areas, may execute business processes across an enterprise, and may include one or more levels of management across an enterprise.

The operational data may include time-stamped process event logs produced by the execution of one or more processes by the application which may include informative data related to the execution of the one or more processes. For example, monitoring data may include time-series numeric data, such as, <timestamp, measurement, value> in sampling intervals such as, 1 second/10 seconds/1 minute/5 minutes/and/or 10 minutes. Operational log data may include time-series semi-structural data, such as, <timestamp, source, log-level, textual log message>. Event and/or alerts operational data may include time-series semi-structural data, such as, <timestamp, source, severity, situation, textual event message>. Tickets and/or events operational data may include time-series based semi-structural data, such as, <open-timestamp, severity, type, owner, status, symptom, root cause, resolution, close-timestamp>. Change and/or service request operational data may include time-series based semi structural data, such as, <timestamp, type, status, textual change message, change impact, change impact, change window, rollback solution>.

The data compression module 150 may be configured to receive the operational data from the one or more applications directly. The data compression module 150 may receive the operation data related to each of the one or more application in real time. The operational data received from the one or more applications may include different data types. As will be explained in more detail below with respect to at least step 204, the data compression module 150 may perform one or more pre-processing functions and/or normalizing functions on the raw operational data received from the one or more applications, such as, but not limited to, formatting the operation data to a common format. The operation data mat be stored in a database 130 (e.g., knowledge corpus).

At 204, the data compression module 150 profiles the operational data. The data compression module 150 may profile the operational data received and/or accessed at step 202 utilizing one or more normalizing functions. The data compression module 150 may profile the raw operational data received at step 202 utilizing the one or more normalizing functions to moderate variance amongst the operational data.

The one or more normalizing functions may include, but are not limited to including, log template mining, variable extraction (e.g., variable mining), identifying correlation patterns, multi-variant pattern mining, entity and relationship mining, amongst other normalizing functions which may be utilized by the data compression module. As will be explained in more detail below, the data compression module 150 may utilize one or more machine learning algorithms, deep learning algorithms, and/or natural language processing techniques in performing the one or more normalizing functions described above. The normalized operational data may include, but is not limited to including, log templates, variables, a multi-variant model, and/or entity relations derived from the operational data utilizing the one or more normalizing functions.

Log template mining may include event mining and/or ticket mining and the data compression module 150 may utilize a similar method in variable mining (e.g., variable extraction). Log templates may be the constant text in operational data logs. The data compression module 150 may vectorize message bodies of logs, events, tickets, and/or extracted features of the operational data message bodies using one or more machine learning models, deep learning models, and/or natural language processing techniques. The data compression module 150 may utilize, but is not limited to utilizing, Bag of Words (BoW), Term Frequency-Inverse Document Frequency (TF-IDF), Word2Vec, Doc2Vec, and/or Bidirectional Encoder Representations from Transformers (BERT) models, in vectorizing the message bodies and/or extracting features from the message bodies. The data compression module 150 may utilize Word2Vec for computing a feature vector for each word in the database 130 (e.g., knowledge corpus) and/or the operational data, Doc2Vec for computing a feature vector for each operational log, and BERT model for determining a word embedding for each word and/or string of code of the operational data based on a position of each word and/or string of code within the operational data. Additionally, the data compression module 150 may cluster the message bodies based on vectors and/or features derived using at least, k-means clustering, hierarchal clustering, autoencoders, amongst other clustering techniques. The data compression module 150 may utilize a support setting to extract frequent sequence words, wherein the support setting may additionally utilize machine learning and/or deep learning algorithms such as, but not limited to, Apriori algorithm, Frequent Pattern Tree (FP-Tree), and/or Frequent Pattern growth (FP-growth), wherein the FP-Tree may be the data structure of the FP-growth algorithm for mining frequent message bodies of the operational data from the database 130 (e.g., knowledge corpus) based on association rules of the support setting. The data compression module 150 may perform the above normalization techniques for each template, wherein each template is a type of operational data and/or type of log, and calculate the correlation of the one or more templates in identifying correlated patterns. For example, one transaction may generate a plurality of operational data logs and each of the plurality of operational data logs may have a relationship (e.g., interactions, interdependencies, properties). As will be explained in more detail below with respect to at least step 206, the data compression module 150 may utilize the one or more log templates derived from the log template mining and/or variable mining (e.g., variable extraction) in at least identifying sequences, such as, but not limited to, log transaction sequences, event sequences, ticket sequences, which may be used by the compression module 150 in extracting frequent sequences from the operational data which may be used in building one or more dictionaries. The one or more dictionaries may be stored in the database 130 (e.g., knowledge corpus).

Multiple-variable pattern mining may be performed by the data compression module 150 using one or more machine learning and/or deep learning models. The one or more machine learning and/or deep learning models may utilize clustering algorithms to cluster multiple variables extracted from the operational data. The data compression module may utilize clustering algorithms, such as, but not limited to, k-means clustering, hierarchal clustering, and/or autoencoders. The data compression module 150 may cluster the multiple variables in a multi-variant model. As will be explained in more detail below with respect to step 206, the data compression module 150 may utilize the multi-variant model in deriving multi-variant patterns which may be used in building one or more dictionaries. The one or more dictionaries may be stored in the database 130 (e.g., knowledge corpus).

Entity and/or relationship mining may be performed by the data compression module 150 using one or more machine learning models, deep learning models, and/or natural language processing techniques, such as, but not limited to, Named-entity Recognition (NER) and/or Named Relation Recognition (NRR). The data compression module 150 may utilize at least the above described techniques in extracting a plurality of entities and identifying relationships (e.g., interactions, interdependencies, properties) between each of the entities which may be utilized by the data compression module 150 in identifying interactions between each of the plurality of entities for fields in the same operational logs and/or fields in different operational logs. As will be described in more detail below, the plurality of entities and relationships between each of those entities may be utilized by the data compression module 150 in constructing a key-value set.

The data compression module 150 may construct a key-value set based on the plurality of entities extracted and the relationships (e.g., interactions, interdependencies, properties) and/or parsing unstructured data based on their relationships (e.g., interactions, interdependencies, properties). The key-value set may include a distribution of appearances within the operation data that may indicate the use of an entity specific to the application, an assigned label, and/or a field name. For example, the key-value set may include a list of entities such as thread entities, container entities, transaction entities, service entities, requests, amongst other entities which may be specific to the application. The distribution of appearances within the operation data may include, but is not limited to including, a number of requests for a given request identifier, the size of requests for a given request identifier, the number of requests for a given user identifier, amongst other distributions of appearance. As will be explained in more detail below with respect to at least step 208 the key value set may store operational data patterns most frequently extracted and may include a corresponding key value, wherein the key value may be any one of and/or combination of numbers, letters, symbols, and/or short string codes which corresponds to each operational data pattern frequently extracted. The data compression module 150 may assign labels and/or field names to each of the one or more key values which may be stored in database 130 (e.g., knowledge corpus). The data compression module 150 may utilize one or more common formats for the key value set. For example, a line of an HTTP access log may be parsed based on a common HTTP access log schema. As will be explained in more detail below, the data compression module 150 may count the number of times the line of HHTP access log appears in the operational data which may be utilized in building the one or more dictionaries based on the pattern discovery. The data compression module 150 in this example may utilize a corresponding key value to represent the line of HHTP access log.

As will be explained in more detail below with respect to step 206, the data compression module 150 may utilize the normalized operational data, such as, but not limited to, log templates, variables, the multi-variant model, and/or entity relations in extracting patterns from the normalized operational data which may be used in building the one or more dictionaries to be stored in the database 130 (e.g., knowledge corpus).

At 206, the data compression module 150 extracts patterns from the operational data. The data compression module 150 may extract patterns from the operational data profiled at step 204. The patterns extracted from the operational data by the data compression module 150 may include, but are not limited to including, sequence patterns, variables, graph patterns, and/or multi-variant patterns.

The data compression module 150 may extract sequence patterns and/or variables based on the log templates and variables profiled from the operational data at step 204. The data compression module 150 may utilize one or more pattern mining techniques in extracting a plurality of frequent sequences from a set of sequences given a support setting and/or calculating significant variables. The support setting may be a probability variable which may denote a minimum percentage of a patterns presence in the database 130 (e.g., knowledge corpus). For example, if the support setting is 0.1 the presence of a given sequence should be greater than 10%. As described in more detail above, the set of sequences from which sequence patterns and/or variables may be extracted may include, but are not limited to including, log transaction sequences, event sequences, ticket sequences, amongst other sequences from the operational data. For example, a frequent sequence may be {[Step #, {[template id, probability] }, [variables]]}. A sequence may include multiple steps and each of the multiple steps may have several template presences with their probabilities. As will be described more in step 208, the template id and/or variables may be utilized in retrieving an original log message.

The data compression module 150 may extract graph patterns and/or variables from a set of graphs, the set of graphs may include, but are not limited to including, services interaction graphs, network topology graphs, event graphs, amongst other graphs. For example, a single transaction logged in the operational data may include several calls to backend services, wherein each of the several calls may include calls of other devices. An example of a frequent graph pattern may be {V(variables), E (src, target, variables)}, where E may represent an Edge which may be determined by a source, target, and/or other attributes or variables on the Edge, and V may represent a Vertex which may be specified by variables such as, but not limited to, name, description, type, amount, entities, relationships, amongst other variables.

The data compression module 150 may extract multi-variant patterns based on the multi-variant model profiled from the operational data at step 204. The data compression module 150 may utilize one or more pattern mining techniques in extracting multiple-variable patterns identified within the multi-variant model. The data compression module 150 may utilize the pattern mining techniques in clustering multi-variant measurements into cluster models wherein each cluster may form a steady state (e.g., highly cohesive). For example, a multi-variant measurement may be {State #, center point, variables}.

The data compression module 150 may utilize the patterns described in detail above in building the one or more dictionaries. The data compression module 150 may profile variables, consolidate duplicate variables, classify variables, and/or identify enumerable variables based on the extracted sequence patterns, extracted graph patterns, and/or the extracted multi-variant patterns described above. The one or more dictionaries may be comprised of these variables and stored in the database 130 (e.g., knowledge corpus). As will be explained in more detail below with respect to step 208, the data compression module 150 may utile the one or more dictionaries in transforming the operational data and compressing the operational data.

At 208, the data compression module 150 compresses the operational data. The data compression module 150 may compress the operational data by transforming the operational data into a compressed format using the plurality of extracted patterns. The plurality of extracted patterns may be matched with variables stored in the one or more dictionaries and assigned the key value associated with the corresponding variable.

The data compression module 150 may utilize the patterns extracted from the operational data at step 206 in matching the operational data with the variables stored in the one or more dictionaries using the key value set. The data compression module 150 may utilize the one or more dictionaries in codifying the values of the variables, such as, but not limited to, hostname, IP address, components, services, amongst other codified values. The data compression module 150 may match one or more patterns extracted from the operational data, such as, but not limited to, sequence patterns, variables, graph patterns, and/or multi-variant patterns with variables stored in the one or more dictionaries. As described in more detail with respect to step 204, each of the operational data patterns most frequently extracted may have a corresponding key value stored in the database (e.g., knowledge corpus), wherein the key value may be a template identification based on any one of and/or combination of numbers, letters, symbols, and/or short string codes which correspond to the frequently extracted data pattern.

The data compression module 150 may compress the operational data received related to one or more applications, such as, but not limited to, monitoring data, operational logs, events/alerts, tickets/incidents, change or service requests, trace data, process event logs, database logs, system logs, transaction logs, system management facility (SMF) logs, amongst other data related to the one or more applications and/or the one or more application's related environments (e.g., middleware, operating systems) in real time, in preset intervals (e.g., 5 seconds, 30 seconds, 1 minute, 1 hour), and/or as the data compression module 150 receives a preset number, such as, 20 operational logs.

The data compression module 150 may also retransform the compressed operational data to an original format upon receiving a retrieval inquiry from a user. The data compression module 150 may receive the retrieval inquiry from the user through at least the UI device set 123 of the peripheral device set 114, the EUD 103, and/or another user interface. The data compression module 150 may retransform the compressed operational data to the original format using decompression, wherein decompression may include converting each frequently extracted pattern back to its original format using the key value and/or template identification of the one or more dictionaries.

It may be appreciated that FIG. 2 provides only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for data compression, the method comprising:
receiving operational data;
profiling the operational data using one or more normalizing functions;
extracting a plurality of patterns from the operational data; and
compressing the operational data based on the plurality of patterns extracted.

2. The method of claim 1, wherein profiling the operational data further comprises:
constructing a key value set, wherein the key value set is in a common format and comprised of a plurality of entities and relationships between the plurality of entities.

3. The method of claim 2, further comprising:
building one or more dictionaries based on at least the key value set and the plurality of patterns extracted from the operational data; and
storing the one or more dictionaries in a knowledge corpus.

4. The method of claim 3, wherein the one or more dictionaries are utilized in compressing the operational data.

5. The method of claim 1, wherein the one or more normalizing functions includes at least one or more of, log template mining, variable extraction, correlation pattern identification, multi-variant pattern mining, or relationship mining.

6. The method of claim 1, wherein the one or more normalizing functions are performed using at least one or more of, machine learning models, deep learning algorithms, or natural language processing techniques.

7. The method of claim 1, further comprising:
receiving a retrieval inquiry from a user; and
retransforming the operational data from a compressed format to an original format.

8. A computer system for data compression, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving operational data;
profiling the operational data using one or more normalizing functions;
extracting a plurality of patterns from the operational data; and
compressing the operational data based on the plurality of patterns extracted.

9. The computer system of claim 8, wherein profiling the operational data further comprises:
constructing a key value set, wherein the key value set is in a common format and comprised of a plurality of entities and relationships between the plurality of entities.

10. The computer system of claim 9, further comprising:
building one or more dictionaries based on at least the key value set and the plurality of patterns extracted from the operational data; and
storing the one or more dictionaries in a knowledge corpus.

11. The computer system of claim 10, wherein the one or more dictionaries are utilized in compressing the operational data.

12. The computer system of claim 8, wherein the one or more normalizing functions includes at least one or more of, log template mining, variable extraction, correlation pattern identification, multi-variant pattern mining, or relationship mining.

13. The computer system of claim 8, wherein the one or more normalizing functions are performed using at least one or more of, machine learning models, deep learning algorithms, or natural language processing techniques.

14. The computer system of claim 8, further comprising:
receiving a retrieval inquiry from a user; and
retransforming the operational data from a compressed format to an original format.

15. A computer program product for data compression, comprising:
one or more non-transitory computer-readable storage media and program instructions stored on at least one of the one or more tangible storage media, the program instructions executable by a processor to cause the processor to perform a method comprising:
receiving operational data;
profiling the operational data using one or more normalizing functions;
extracting a plurality of patterns from the operational data; and
compressing the operational data based on the plurality of patterns extracted.

16. The computer program product of claim 15, wherein profiling the operational data further comprises:
constructing a key value set, wherein the key value set is in a common format and comprised of a plurality of entities and relationships between the plurality of entities.

17. The computer program product of claim 16, further comprising:
building one or more dictionaries based on at least the key value set and the plurality of patterns extracted from the operational data; and
storing the one or more dictionaries in a knowledge corpus.

18. The computer program product of claim 17, wherein the one or more dictionaries are utilized in compressing the operational data.

19. The computer program product of claim 15, wherein the one or more normalizing functions includes at least one or more of, log template mining, variable extraction, correlation pattern identification, multi-variant pattern mining, or relationship mining.

20. The computer program product of claim 15, wherein the one or more normalizing functions are performed using at least one or more of, machine learning models, deep learning algorithms, or natural language processing techniques.
